(19) United States
(12) Patent Application Publication
(10) Pub. No.: US 2018/0072628 A1
(43) Pub. Date: Mar. 15, 2018

(54) GRADIENT ZIRCONIA BLANK AND METHODS OF MAKING SAME

(71) Applicant: Jensen Industries Inc., North Haven, CT (US)

(72) Inventors: Donald F. Cornell, Madison, CT (US); Yoonho Jun, Simsbury, CT (US)

(21) Appl. No.: 15/700,976

(22) Filed: Sep. 11, 2017

Related U.S. Application Data
(60) Provisional application No. 62/385,389, filed on Sep. 9, 2016.

(51) Int. Cl. C04B 35/488; C04B 35/626; A61C 13/00

(52) U.S. Cl. CPC C04B 35/4885; C04B 35/62625; A61C 13/0022; C04B 2235/6027; C04B 2235/3217; C04B 2235/3225; C04B 2235/3244

(57) ABSTRACT

Zirconia blanks useful for dental CAD/CAM applications, particularly, zirconia blanks made from a single colloidal solution containing multiple particle populations which form a gradient which may be used to impart color or other characteristics comparable to that found in natural teeth, and methods of making them. Some embodiments relate to colloidal casting methods of making such blanks, and blanks made by the method.

### CROSS REFERENCE TO RELATED APPLICATIONS

This application claims the benefit of U.S. Provisional Patent Application Ser. No. 62/385,389, filed on Sep. 9, 2016, entitled “Gradient Zirconia Blank and Methods of Making Same,” the entire contents of which is hereby incorporated by reference herein.

### TECHNOLOGY FIELD

This disclosure relates to zirconia blanks useful for dental CAD/CAM applications. More particularly, this disclosure relates to zirconia blanks made from multiple particle populations which form a gradient which may be used to impart color or other characteristics comparable to that found in natural teeth, and methods of making them. Some embodiments relate to colloidal casting methods of making such blanks, and blanks made by the method. In some instances, the zirconia blank is a pre-shaded polychromatic blank.

### BACKGROUND

For years, ceramics, such as zirconia, have been used to make artificial teeth or dental reconstructions. When zirconia is used alone, the result is an unnaturally white product which requires subsequent coloring. Because of this, a variety of coloring applications have been developed. Coloring solutions which can be artfully applied to the surface of the artificial tooth have been created as well as other surface coloring techniques. In other coloring techniques, multiple separate layers of colored zirconia are put together to form a gradient. Monochromatic pre-shaded zirconia products are also available.

Zirconia may be processed to provide different properties or characteristics such as strength, translucency, and other properties. Upon heating, pure zirconia undergoes phase transformation from monoclinic to tetragonal at 1170° C. and from tetragonal to cubic at 2370° C. Upon cooling, it undergoes phase transformation from cubic to tetragonal and from tetragonal to monoclinic. Phase transformation from tetragonal to monoclinic is rapid and 3 to 5% of volume expansion occurs. This generates large enough stress in the sintered pure zirconia to cause cracks. Addition of some metal oxide such as yttrium oxide, magnesium oxide, calcium oxide and cerium oxide to zirconia can stabilize high temperature phase, cubic, at room temperature. When stabilizers are added to zirconia less than the amount required for full stabilization, part of zirconia may exist as tetragonal phase. This type of zirconia is called partially stabilized zirconia (PSZ). The tetragonal phase can be transformed to monoclinic when stress is applied. Because the transformation accompanies with volume expansion, it can close propagating cracks and this is called transformation toughening. PSZ has higher strength and toughness than fully stabilized zirconia because of the toughening. If about 3 mol % yttrium oxide is added as a stabilizer and particle size is smaller than a critical size, almost 100% of the existing phase can be tetragonal. This is called tetragonal zirconia polycrystal (TZP). TZP has high strength, but low translucency because refractive index varies depending on crystallographic direction. Polycrystalline sintered body has randomly oriented grains and light is scattered at the grain boundary. Light scattering becomes stronger when refraction index variation is large depending on crystallographic direction. Fully stabilized zirconia has cubic phase and is not transformed to monoclinic upon application of stress. Due to the absence of toughening mechanism, fully stabilized zirconia has lower strength than TZP. But, it has higher translucency because refractive index of cubic phase does not depend on crystallographic direction and so less light scattering occurs. As used herein, and commonly in the industry, 3Y zirconia means 3 mol % yttrium oxide doped zirconia. 5Y zirconia means 5 mol % yttrium oxide doped zirconia which is more stabilized than 3Y zirconia. 3Y zirconia has higher strength and lower translucency than 5Y zirconia.

Zirconia blanks currently are manufactured by a pressing method or a colloidal casting method. FIGS. 1A and 1B depict these methods schematically.

In the pressing method, zirconia particles are filled in a mold and a uniaxial pressure is applied to the mold to form blanks. Non-uniform stress field in uniaxial pressing generates non-uniform structure in the blanks which causes deformation in sintered zirconia restorations. After uniaxial pressing, cold isostatic pressing (CIP) can be performed to make blanks more uniform. For example, to achieve multi-layer blanks in a pressing method such as depicted in FIG. 1A, serial deposition of multiple layers and pressing form a blank in a mold. Drawbacks of this method include the clear boundary of color between layers, and the need for multiple layers of multiple colors to attempt to create a smooth transition or gradient.

The colloidal method is a type of filtration method. Zirconia powder is suspended in a liquid medium, such as water, for casting. The colloidal solution is poured into a mold having a porous solid in one end of the mold. By application of vacuum or pressure, the particles are filtered against the porous solid. This process is repeated for a number of times to achieve the desired appearance and properties by accumulating multiple colloidally deposited layers. Thus, a gradient-like appearance can be achieved through multiple pours creating multiple layers.

FIG. 1B depicts a colloidal casting method where, layer by layer, a colloidal solution containing colored particles is deposited such that each layer is a different color, leading to a desired effect, such as a gradient. Each layer is poured after formation of the previous is complete. Small colored particles tend to concentrate at the interfaces creating more intense color which appears as a distinct boundary at the interface. Like the pressing method, this method includes the clear boundary of color between layers, and the need for multiple layers of multiple colors to attempt to create a smooth transition or gradient. Further, impurities and small colored particles are pushed up to the top area of each layer as it is formed. Because each layer is completed before the next is laid down, impurities can be trapped in the interface between the layers. This method also tends to form microvoids after presintering, since the impurities burn out leaving a void behind. This could necessitate the need for a clean room facility.

Thus, new and better techniques for forming gradient blanks for dental CAD/CAM operations are needed.

### SUMMARY

Some embodiments provide a ceramic blank suitable for use in dental reconstruction, the ceramic blank comprising a first plurality of ceramic particles having a first mean particle size and a first color; a second plurality of ceramic particles having a second mean particle size and a second color; wherein at least one of the first mean particle size and the second mean particle size or the first color and the second color are different from one another; and wherein the first plurality of ceramic particles and the second plurality of ceramic particles form a gradient based on relative mean particle size and/or particle size distribution.

In some embodiments, one or more additional pluralities of ceramic particles, each said plurality of ceramic particles having a mean particle size and a color associated therewith; and wherein each additional plurality of ceramic particles contributes to the gradient based on its relative mean particle size and/or particle size distribution.

In some embodiments, the color of at least one of the first plurality of ceramic particles and the second plurality of ceramic particles is the natural color of the ceramic.

In some embodiments, the ceramic is zirconia.

In some embodiments, the color of the first plurality of ceramic particles differs from the color of the second plurality of ceramic particles.

In some embodiments, the mean particle size of the first plurality of ceramic particles differs from the mean particle size of the second plurality of ceramic particles.

Some embodiments provide a method of making a ceramic blank suitable for use in dental reconstruction, the method comprising mixing a solution comprising a first plurality of ceramic particles having a first mean particle size and a first color, and a solution comprising a second plurality of ceramic particles having a second mean particle size and a second color, wherein at least one of the first mean particle size and the second mean particle size or the first color and the second color are different from one another; pouring the mixed solution into a mold; forming a gradient based on mean particle size by allowing the first plurality of ceramic particles and the second plurality of ceramic particles having a second mean particle size to settle; forming the ceramic blank by filtration.

In some embodiments, the first plurality of ceramic particles is provided as a first colloidal solution of the first plurality of ceramic particles, and the second plurality of ceramic particles is provided as a second colloidal solution of the second plurality of ceramic particles.

In some embodiments, the solution further comprises one or more additional pluralities of ceramic particles, each said plurality of ceramic particles having a mean particle size and a color associated therewith, wherein each additional plurality of ceramic particles contributes to the gradient based on its relative mean particle size and/or particle size distribution.

Some embodiments provide a method of making a ceramic blank suitable for use in dental reconstruction, the method comprising mixing a solution comprising a first population of ceramic particles having a first set of particle size properties, and a second population of ceramic particles having a second set of particle size properties, wherein at least one of the set of particle size properties is different between the first population and the second population; pouring the mixed solution into a mold; forming a particle gradient based on the first and second sets of particle size properties; forming the ceramic blank by filtration.

In some embodiments, the first population of ceramic particles is provided as a first colloidal solution of the first population of ceramic particles, and the second population of ceramic particles is provided as a second colloidal solution of the second population of ceramic particles.

In some embodiments, the solution further comprises one or more additional populations of ceramic particles, each said population of ceramic particles having a set of particle size properties associated therewith, wherein each additional population of ceramic particles contributes to the gradient based on its set of particle size properties.

In some embodiments, each set of particle size properties is selected from average particle size, particle size distribution, number of particles, or a combination thereof.

In some embodiments, one or more other property is associated with each of said first and second population, wherein the one or more other property is independently selected from color, ability to absorb/adsorb color, yttrium content, strength, translucency, or combinations thereof.

Other embodiments will be readily appreciated by those of skill in the art upon reading this specification without differing from the spirit and scope of this disclosure.

### BRIEF DESCRIPTION OF THE DRAWING FIGURES

The patent or application file contains at least one drawing executed in color. Copies of this patent or patent application publication with color drawing(s) will be provided by the Office upon request and payment of the necessary fee.

FIG. 1A is a schematic rendering of a prior multi-layer pressing method.

FIG. 1B is a schematic rendering of a prior multiple sequential colloidal casting method.

FIG. 1C is a schematic rendering of a single pour colloidal casting method as described herein.

FIG. 2 is a schematic rendering of a polychromatic blank and methodology as described herein.

FIG. 3 is a flow chart of the general methodology of the single pour colloidal casting technique described herein.

FIG. 4 depicts the control and effects according to some methods described herein.

FIG. 5 depicts the control and effects according to some methods described herein.

FIG. 6. Depicts the effects of altering the colloidal stability on color width and intensity, as well as gradient and other parameters.

FIG. 7 is a photo depicting a blank made in accordance with example 1 described herein.

FIG. 8 is a photo depicting a blank made in accordance with example 2 described herein.

FIG. 9 depicts several blanks made in accordance with examples described herein.

FIG. 10 depicts a blank made in accordance with example 8 described herein.

### DETAILED DESCRIPTION

The blanks and methods of making them disclosed herein take advantage of various particle sizes, particle size distribution, dispersion, and sedimentation or settling. By varying these and other properties or characteristics, the placement of various particles within a blank can be predicted. By knowing where particles are likely to be, the characteristics or properties of the blank can be controlled by altering the characteristics or properties of the various particles.

First, however, the predictability of particle placement is established. Once known, changing the properties of the particles changes the properties of the blank they make.

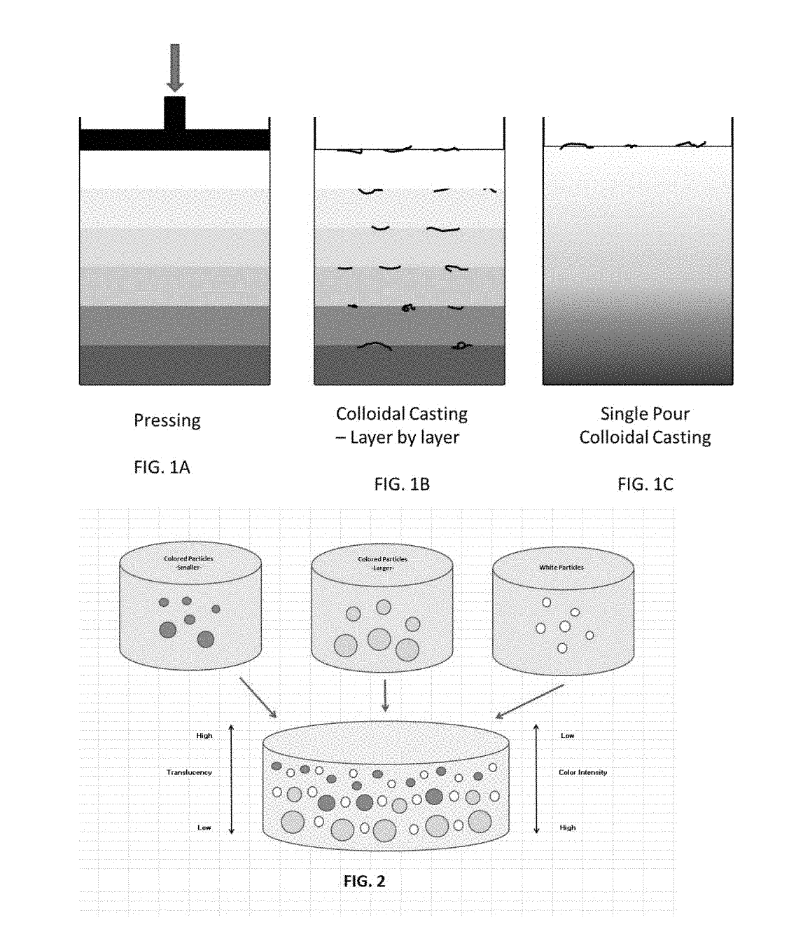

As described herein, a single pour of a single colloidal solution is employed to create a blank having a gradient of various particle sizes, with the smaller particle sizes being at the top and the larger particle sizes being at the bottom, and an intermingling of the two therebetween. This is illustrated in FIG. 1C. FIGS. 1A and 1B illustrate prior methods. It is difficult to see due to printing constraints, but the prior methods involve creating the appearance of a gradient through application of several distinct layers. In contrast, the methods described herein, and illustrated in FIG. 1C, result in a true gradient, created without distinct layers. In establishing this particle size gradient, two or more particle populations, each having an average particle size and a particle size distribution are made into a colloidal solution. In doing so, individual solutions may be made first and subsequently combined, or a single solution containing the two or more particle populations may be mixed together. The colloidal solution containing the two or more particle populations is mixed and then poured into a mold. Suction may be applied as an option, and the liquid is filtered to leave behind a sediment defined by a particle size gradient from small particles (top) to large particles (bottom), with an intermingling therebetween.

The gradient can be controlled by altering any or all of the relative amounts of each particle population, the relative sizes of each population, the difference between the relative particle sizes of each population, etc. In some embodiments, the difference between the relative particle sizes or two population is preferably at least 5%. In some embodiments, the difference in relative particle size between two populations is between about 5% and 500%. In some embodiments the difference in relative particle size between two population is about 5%, 7%, 10%, 15%, 20%, 25%, 30%, 40%, 50%, 60%, 70%, 80%, 90%, 100%, 150%, 200%, 300%, 400%, 500%, or any value or range of values between any two of these.

For example, in a two particle population composition having approximately equal amounts of two different particle populations, where the difference in particle size between the two populations is relatively small, the gradient is relatively uniform, that is, the first and second populations are relatively evenly distributed throughout the blank. In a similar two particle population, having a relatively larger difference in particle sizes between the two populations, a more distinct gradient is made, with small particles being present on the top and large particles being at the bottom, and an intermingling therebetween. The intermingling occurs not only from mixing of large and small particles from the different populations, but also from the presence of large and small particles within each population due to the particle size distribution in each population.

Similarly, where the ratio of one population to another is altered, the “band” of each population is similarly altered. That is when the amount of one population is larger than the amount of the other population, a broader perceivable “band” of that population occurs. A band need not, and preferably, does not have a sharp edge, but rather, due to the gradient formed, transitions gradually from one “band” to the next.

Additional particle populations may be introduced. For example, three, four, five, or more particle populations may be used to achieve the desired final properties. In some instances, at least two particle populations have different average particles sizes. In some instances, at least three particle populations have different average particle sizes.

Real benefits of this system are seen when one or more particle populations have different characteristics or properties such as, but not limited to, color, color absorbability, aluminum oxide content, yttrium oxide content, translucency, strength, etc. By selecting one or more quality for a particular particle population, the location of that quality or property can be controlled. For example, when a relatively small particle population is colored, it can be predicted that the colored population will be present at the top of the blank. Colored particles make demonstration of concept easier to visualize as seen throughout the Figures, but any property/characteristic can similarly be placed in predictable locations using the methods described herein. The discussion below will focus on the distribution of colored particles through the blank, but any property or quality can be similarly placed by controlling any of the relative particle size properties of average particle size, particle size distribution, relative amounts of particles, etc. of each particle population.

As used herein, a “population of particles” or similar term, is a plurality of particles sharing similar properties or characteristics. Typically, a population represents a particular set of particle size properties and other properties, such as color, yttrium content, strength, translucency, and other properties.

By separating particles of different color or color intensities (for example colored particles from white/unshaded particles, or dark colored particles from lighter colored particles) depending on particle size and/or density in a poured colloidal solution, that is, by providing particles of various sizes and colors, a color palette and gradient can be created from a single pour of a single colloidal suspension. In some embodiments, additional pours, typically, but not necessarily, prior to filtration can be used to impart special effects, such as an incisal effect, but the main body can be made in a single pour.

This method has several advantages, including but not limited to gradient of color formed by a pour of colloidal solution mixture of two or more colored particles (where the color includes any desired shade, and or the natural color of unshaded zirconia), and no impurity trapped inside the blank, etc.

In general, larger particles will settle to the bottom of a mold, smaller particles will float to the top, and medium sized particles will find a middle ground, creating a natural gradient. By employing at least two different colors, and preferably at least two different particle sizes, in varying amounts, the gradient may be controlled. Manipulation of the relative amounts of each particle size, and the color associated with them, one can control the intensity of color throughout the blank, or at various levels within the blank.

It should be recognized that reference to particle size herein refers to mean particle size. It should be further recognized that with any particle size determination, there is a particle size distribution, whereby there are a number of particles above and below the mean particle size. This too can be used to an advantage. By being aware of and controlling the particle size distribution, the gradient effect can be manipulated. For example, although it is expected that relatively large size particles will settle to the bottom of the mold, any “large particle” component will have smaller particles in its particle distribution. These particles will settle less, and intermingle with the relatively larger particles of a relatively small size particle. In traditional methods, each layer or band would have been poured separately, with no intermingling of the two. In a single pour, the smaller particles of one size are free to mingle with the larger particles of another size—thus creating a smooth, natural gradient effect. FIG. 2 depicts a theoretical rendition of a three particle system, having relatively large particles (yellow), relatively small particles (brown), and relatively smaller particle (white) and a blank formed by mixing the three into a single solution and forming the blank.

FIG. 2 also shows the colored large particles tend to settle toward the bottom, making color intensity greater at the bottom. Conversely, the smallest, white particles tend to rise, decreasing color intensity at the top. Of course, were the relationship altered, such that the white particles were the largest, then color intensity would be low at the bottom. Thus, by choosing and pairing color and size, one can control the desired parameters of color and color intensity, and other parameters.

In general, the methods involve preparing an at least two colloidal solutions of zirconia particles, each colloidal solution comprising particles having a mean particle size and a color. At least one of the at least two colloidal solutions has a different colored particle. A gradient is achieved by employing multiple colors and multiple sizes, although it is contemplated that a multi-color system having similar particle sizes could be useful in some situations.

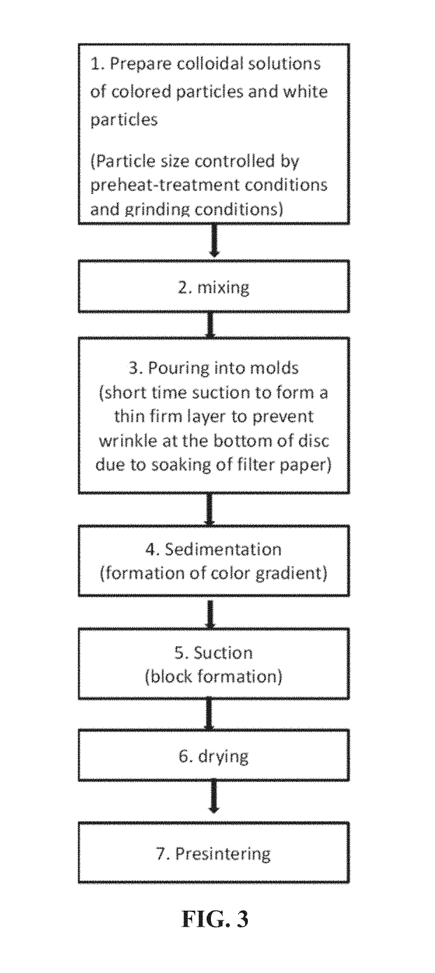

FIG. 3 sets forth a basic flow chart of the general procedure. Once the colloidal solutions have been made with the desired colors and desired particle sizes, the desired solutions are mixed together into a single colloidal solution. The mixing carried out is sufficient to provide for uniform distribution of particles through the solution. This solution is then poured into a mold. In some embodiments, the mold is provided with a filter paper In some embodiments, a vacuum or pressure is applied for a short period to set the filter paper properly to avoid wrinkles.

Sedimentation is allowed to occur within the mold, whereby larger particles settle and a gradient is made based on the particle size, and the colors associated with each size. Suction (vacuum) can be applied to facilitate blank formation, once the color gradient is formed. The resultant blank is dried and then may be presintered for use as a dental blank.

Particle size is determined by controlling heat treatment temperature, time, grinding, and or separation techniques. In addition, stability of colloids affects particle size and particle size distribution.

Temperature: exposing the particles to higher temperature yields larger aggregates.

Time: exposing particles to the same temperature, but for longer periods of time, will yield larger aggregates, compared to particles exposed to the same temperature for a shorter period of time.

Grinding: particle size can be controlled via choice of grinding instrument, grinding surface, time, and/or other parameters. Generally speaking, the longer the grind time, the smaller the particle.

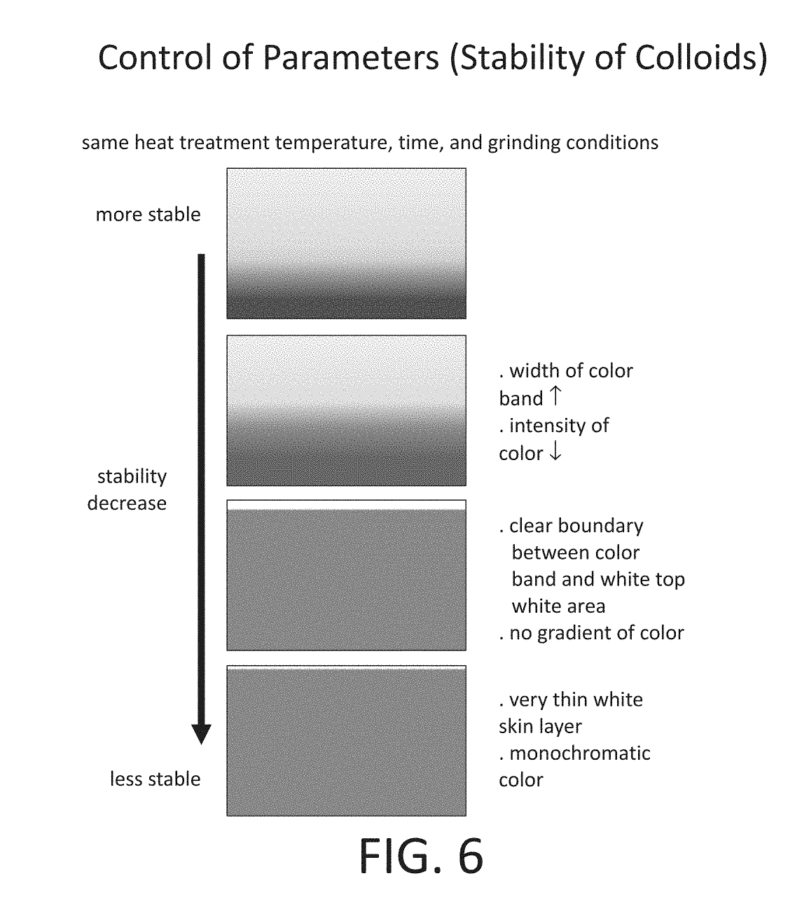

Stability of colloids: Colloids are stable when repulsive force between particles is high enough to prevent particles from adhering to one another. Once the colloid is destabilized, particles form aggregates whose size increases successively. The aggregates may settle out by gravity. Control of stability of colloids and relative amount of each particle population provide an additional control over locations and widths of color band and transition area in the blank. FIG. 6 is a schematic showing how the stability of colloids can change locations and widths of color band and transition area in the blank. Parameters that determine stability of colloids are pH, type and concentration of dispersants, type and concentration of electrolytes, dispersing medium, and others as is known in the art.

Separation: various separation techniques can be used to control the particle size, either maximum or minimum, which can affect the distribution. Centrifugation can be used to separate large particles from colloidal solutions. Screen filters can be used to establish minimum or maximum particle sizes. Combining minimum and maximum filtration allows control of the minimum and maximum particle sizes establishing a desired particle size range, which could be important in some applications.

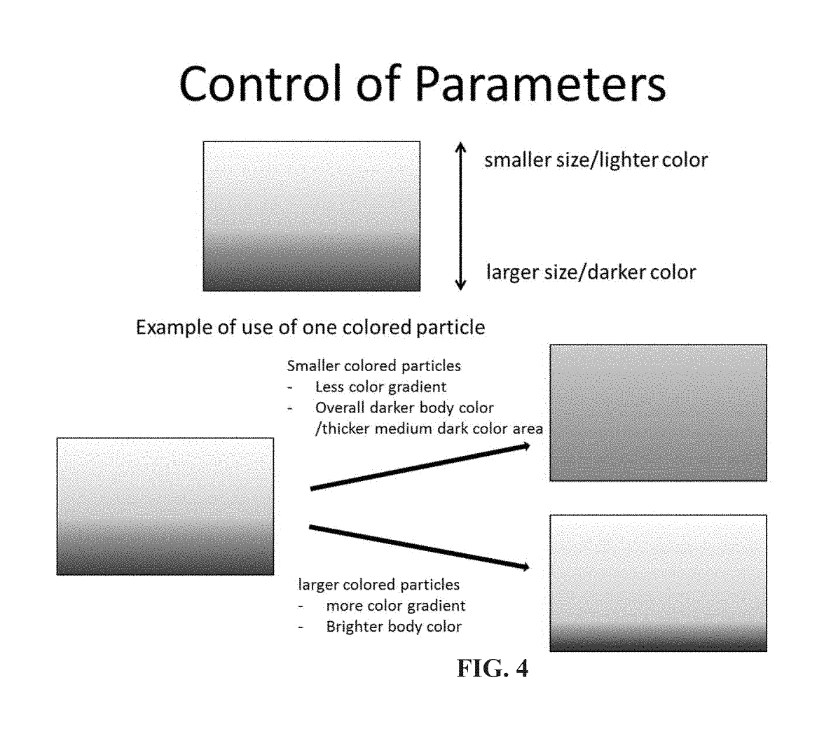

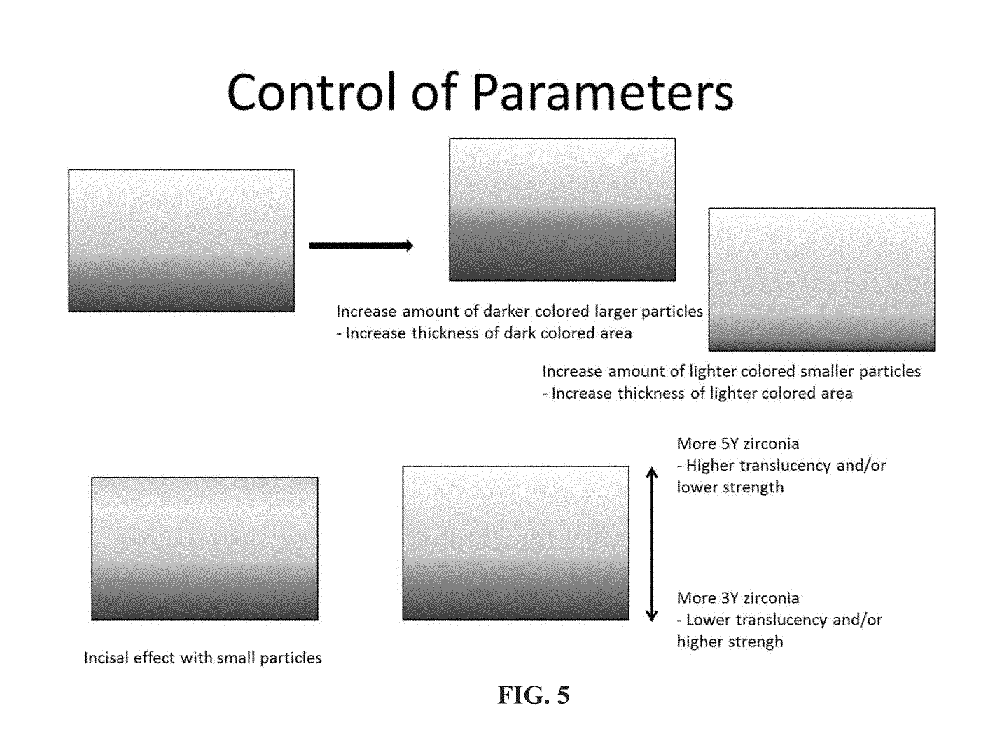

In the finished blank, a few parameters are worth noting: the position (or sequence) of the colors, the translucency of each color band, the width of color, and other properties. FIGS. 4-5 depict some general concepts and results when altering the amount and/or type of colored particles. Generally speaking, the mean particle size associated with a particular color determines where that color will appear most prominently in the blank. The width of that color will depend upon the amount of a particular color of particle, more particles means more width.

Small particles which can give incisal effect on the top area. This can be added during mixing or after sedimentation. Often to add to the incisal effect, these particles can be blue, gray, or violet in color, although that choice can be left to the blank formulator who is attempting to match existing, natural teeth.

The particles can have different composition to generate strength and/or translucency gradient in the blank. For example, 5Y zirconia can be added to the mix to increase translucency at the expense of strength, and 3Y zirconia can be added to increase strength at the expense of translucency. In some embodiments, a mix of different compositions and/or colors could be used with similar mean particle size to impart desired characteristics into any given color band.

The use of the term “color band” or “band” is for convenience only. In practice, the methods and blanks described herein result in relatively smooth transitions between such bands. The term is not intended to mean or imply that there is a physical and/or visible separation—just the opposite, the techniques herein create an inseparable gradient resembling a natural coloring. Nevertheless, in some situations, it may be desirable to have a more distinct gradient, or conversely, a more uniform gradient. This can be controlled by altering the difference between particle sizes between two colors. A smaller particle size difference leads to more blending or intermixing and a more uniform or gentle gradient. A larger particle size difference leads to more distinct sedimentation and more readily discernable bands and color boundaries.

### EXAMPLES

### Example 1

### White and Pink Zirconia

Zpex (3y) zirconia, white, was ground for 1 hour to achieve a relatively uniform particle size.

Zpex (3Y) zirconia, pink, was heated at 600° C. for 4 hours and then ground for 30 minutes.

Although, color aside, the two populations are made of the same material (Zpex (3Y) zirconia), the difference in heating and grinding yield relatively different particle sizes, with the white particle population having a relatively smaller particle size and the pink particle population having a relatively large particle size.

For Zpex (3Y) white zirconia colloidal solution, 50 g of 68.2 wt. % white Zpex (3Y) zirconia aqueous solution was prepared.

For Zpex (3Y) pink zirconia colloidal solution, 10 g of 50 wt. % pink Zpex (3Y) zirconia aqueous solution was prepared.

The first and second colloidal solutions were combined and mixed for 10 seconds. The mixed solution was then poured into a mold, and slight suction applied for about 20 seconds. Suction was removed, and the solution was allowed to settle for 10 hours. Suction was then again applied to facilitate blank formation. The blank was then dried and presintered.

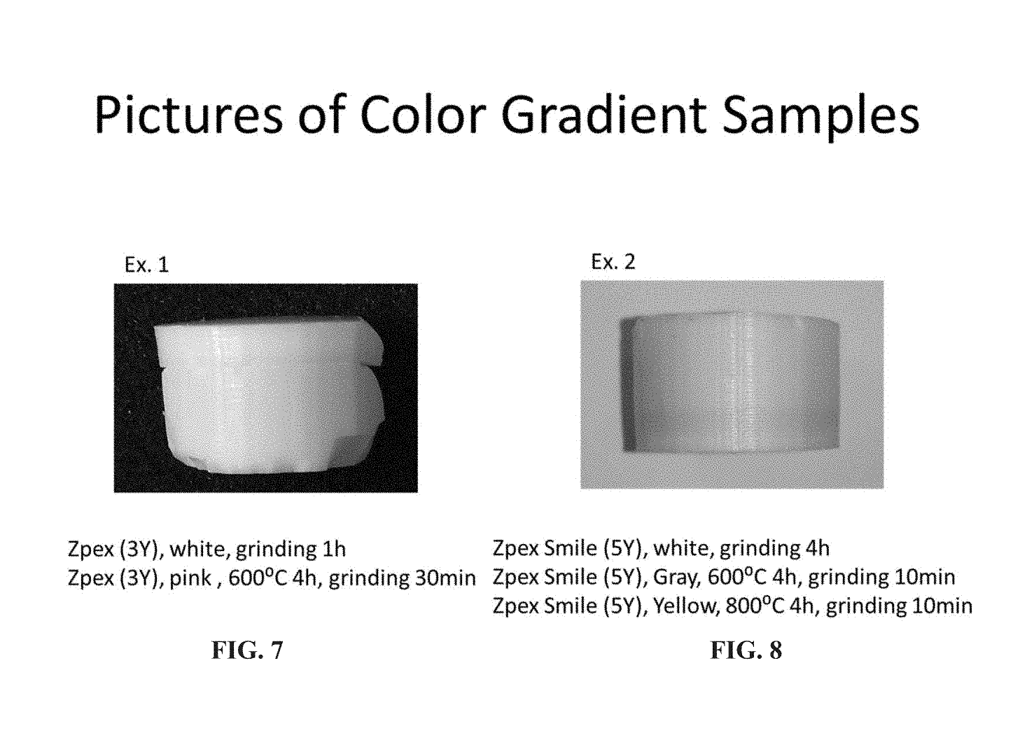

FIG. 7 depicts the resultant blank. Distinct color bands can be seen for white and pink, with a transition area therebetween.

### Example 2

### Three Color (White, Gray, and Yellow)—Colored Particle Sizes Were Controlled by Heat Treatment Temperature

Zpex Smile (5Y) zirconia, white, was ground for 1 hour to yield relatively small particles.

Zpex Smile (5Y), gray, was heated at 600° C. for 4 hours then ground for 10 minutes to yield relatively medium sized particles.

Zpex Smile (5Y), yellow, was heated at 800° C. for 4 hours then ground for 10 minutes to yield relatively large sized particles.

Again, aside from color, each particle population is made from substantially the same material, but relatively different particle size populations (white=small, gray=medium, yellow=large) result from the different heating and grinding applications.

For Zpex Smile (5Y) white zirconia colloidal solution, 50 g of 68.2 wt. % white Zpex Smile (5Y) zirconia aqueous solution was prepared.

For Zpex Smile (5Y) gray zirconia colloidal solution, 5 g of 50 wt. % gray Zpex Smile (5Y) zirconia aqueous solution was prepared.

For Zpex Smile (5Y) yellow zirconia colloidal solution, 10 g of 50 wt. % yellow Zpex Smile (5Y) zirconia aqueous solution was prepared.

The first, second, and third colloidal solutions were combined and mixed for 10 seconds. The mixed solution was then poured into a mold, and slight suction applied for about 10 seconds. Suction was removed, and the solution was allowed to settle for 13 hours. Suction was then again applied to facilitate blank formation. The blank was then dried and presintered.

FIG. 8 depicts the resultant blank. The larger yellow particles are distinctly seen at the bottom transitioning to gray and then white. The distinction between the gray and white “bands” is more difficult to see, evidencing a smooth transition from one to the next.

### Examples 3-7

### Embodiments of Control of Parameters in FIG. 4 and FIG. 5

Example 3 explores the control of parameters as illustrated in FIG. 4. In FIG. 3, the left sample used yellow powder that was heat-treated at lower temperature then yellow powder used in the right sample. Lower particle size difference results in less color gradient and overall darker body color. Greater particle size difference results in more discernible color band and brighter body color, as shown in the right hand sample.

Examples 4-7 explore the control of parameters as illustrated in FIG. 5.

Example 4 used only a yellow particle population and a white particle population. Increases in the relative amount of colored particles results in increase of color intensity due to higher concentration of colored particles and wider band color band. The right-hand sample in Example 4 has a greater amount of yellow particles than the left sample.

Examples 5-7 used a large size yellow particle population, a medium size gray particle population, and small size white particle population. The right sample in Example 5 has a greater amount of the yellow particle population which results in more intense and wider yellow band and more yellowish body color.

The right sample in Example 6 has a greater amount of the gray particle population which results in more intense and wider gray band and more grayish body color.

The right sample in Example 7 has more of both the medium size gray particle population and the large size yellow particle population. This results in more intense and wider yellow and gray bands and more discernible bands.

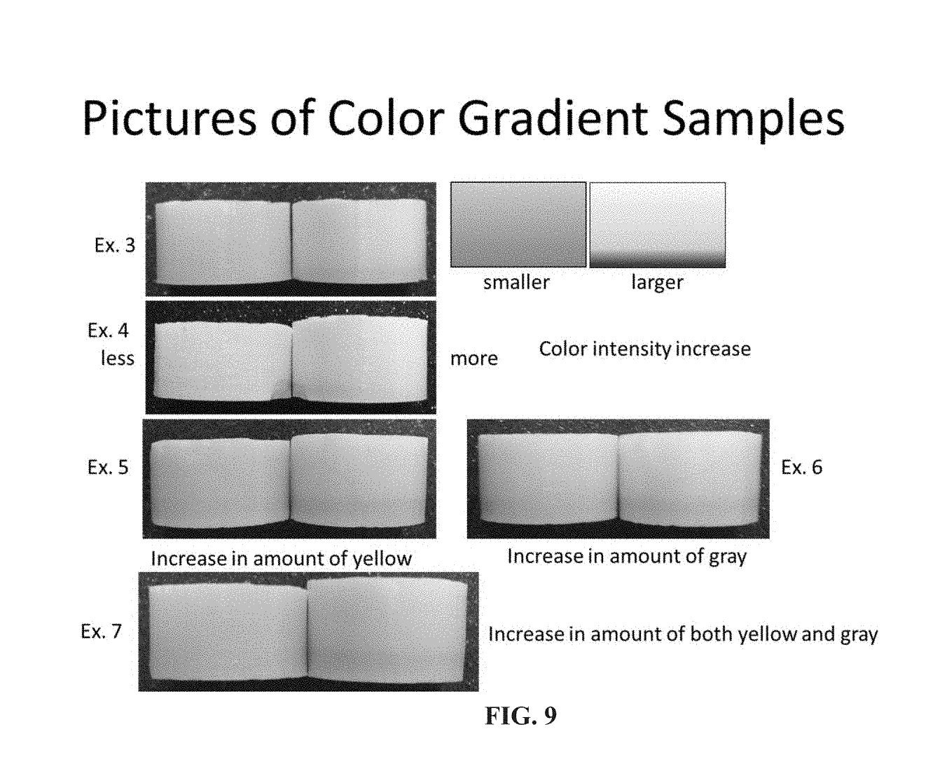

Examples 3-7 with results depicted in FIG. 9 explore the effect of altering parameters such as particle size differential, particle size and/or amount, change in relative amounts of color.

| Example | | Left | Right | Notes |
|---|---|---|---|---|
| 3 | White | Lower | Greater | Greater particle size |
| | Yellow | particle size | particle size | difference creates more |
| | | difference | difference | discernable color band |
| 4 | White | | Relatively | Increased color intensity |
| | Yellow | | cmore olor | |
| | | | particles | |
| 5 | White | | Increase in | Increased yellow color |
| | Gray | | yellow | intensity and width; |
| | Yellow | | | more discernable band |
| 6 | White | | Increase in | |
| | Gray | | gray | |
| | Yellow | | | |
| 7 | White | | Increase in | Increased yellow and gray |
| | Gray | | both yellow | color intensity and width; |
| | Yellow | | and gray | more discernable band |

Examples 3-7 show that through manipulation of one or more parameters or ingredients, such as color, particle size, particle size distribution, particle size differential, etc. a wide variety of colors and gradients are achievable.

### Example 8

### Three Color (White, Gray, and Yellow)—Colored Particle Sizes Were Controlled by Grinding Time

Zpex Smile (5Y) zirconia, white, was ground for 1 hour to yield relatively small particles.

Zpex Smile (5Y), gray, was heated at 600° C. for 4 hours then ground for 10 minutes to yield relatively medium sized particles.

Zpex Smile (5Y), yellow, was heated at 600° C. for 4 hours then ground for 5 minutes to yield relatively large sized particles.

For Zpex Smile (5Y) white zirconia colloidal solution, 50 g of 68.2 wt. % white Zpex Smile (5Y) zirconia aqueous solution was prepared.

For Zpex Smile (5Y) gray zirconia colloidal solution, 10 g of 50 wt. % gray Zpex Smile (5Y) zirconia aqueous solution was prepared.

For Zpex Smile (5Y) yellow zirconia colloidal solution, 10 g of 50 wt. % yellow Zpex Smile (5Y) zirconia aqueous solution was prepared.

The first, second, and third colloidal solutions were combined and mixed for 10 seconds. The mixed solution was then poured into a mold, and slight suction applied for about 10 seconds. Suction was removed, and the solution was allowed to settle for 10 hours. Suction was then again applied to facilitate blank formation. The blank was then dried and presintered.

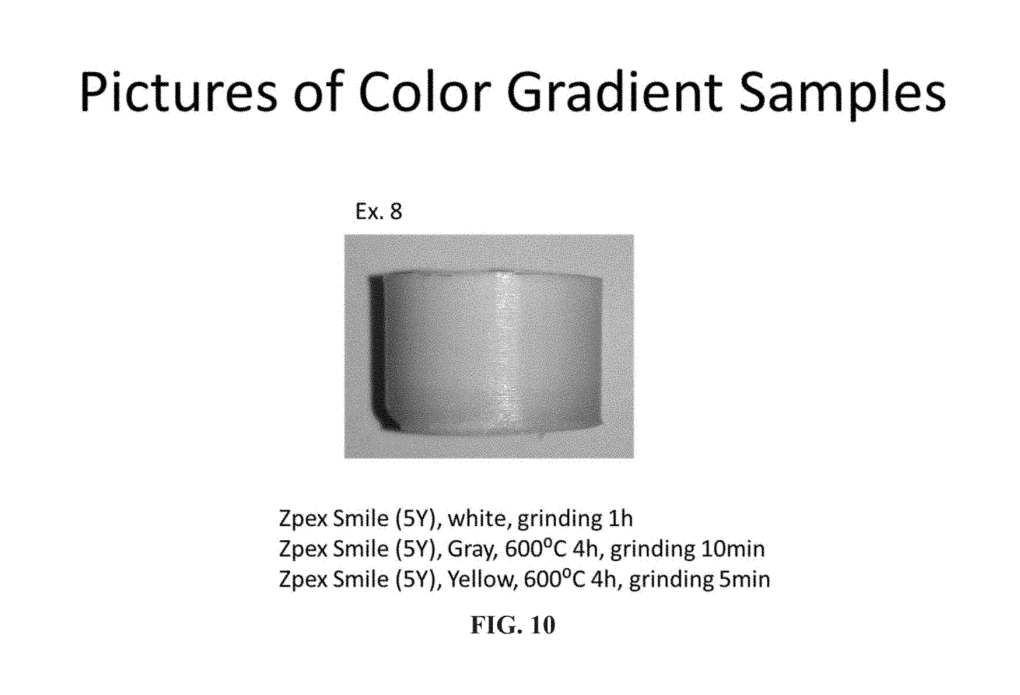

FIG. 10 depicts the resultant blank. The larger yellow particles are distinctly seen at the bottom transitioning to gray and then white. The distinction between the gray and white “bands” is more difficult to see, evidencing a smooth transition from one to the next.

As noted previously, the examples described above focus on color distribution along with the various sized particle populations, but any property or characteristic can be affected similarly to color through choice of materials and relative particle size properties.

The above examples and description are intended for illustration only and are not intended to be limiting. Those of skill in the art will recognize variants that do not depart from the scope or spirit of this disclosure.

What is claimed is:

1. A ceramic blank suitable for use in dental reconstruction, the ceramic blank comprising:
a first plurality of ceramic particles having a first mean particle size and a first color;
a second plurality of ceramic particles having a second mean particle size and a second color;
wherein at least one of the first mean particle size and the second mean particle size or the first color and the second color are different from one another; and
wherein the first plurality of ceramic particles and the second plurality of ceramic particles form a gradient based on relative mean particle size and/or particle size distribution.

2. The ceramic blank of claim 1, wherein:
one or more additional pluralities of ceramic particles, each said plurality of ceramic particles having a mean particle size and a color associated therewith; and
wherein each additional plurality of ceramic particles contributes to the gradient based on its relative mean particle size and/or particle size distribution.

3. The ceramic blank of claim 1 or 2, wherein the color of at least one of the first plurality of ceramic particles and the second plurality of ceramic particles is the natural color of the ceramic.

4. The ceramic blank of claim 1, wherein the ceramic is zirconia.

5. The ceramic blank of claim 1, wherein the color of the first plurality of ceramic particles differs from the color of the second plurality of ceramic particles.

6. The ceramic blank of claim 1, wherein the mean particle size of the first plurality of ceramic particles differs from the mean particle size of the second plurality of ceramic particles.

7. A method of making a ceramic blank suitable for use in dental reconstruction, the method comprising:
mixing a solution comprising a first plurality of ceramic particles having a first mean particle size and a first color, and a second plurality of ceramic particles having a second mean particle size and a second color, wherein at least one of the first mean particle size and the second mean particle size or the first color and the second color are different from one another;
pouring the mixed solution into a mold;
forming a gradient based on mean particle size by allowing the first plurality of ceramic particles and the second plurality of ceramic particles having a second mean particle size to settle;
forming the ceramic blank by filtration.

8. The method of claim 7, wherein the first plurality of ceramic particles is provided as a first colloidal solution of the first plurality of ceramic particles, and the second plurality of ceramic particles is provided as a second colloidal solution of the second plurality of ceramic particles.

9. The method of claim 7, wherein the solution further comprises one or more additional pluralities of ceramic particles, each said plurality of ceramic particles having a mean particle size and a color associated therewith, wherein each additional plurality of ceramic particles contributes to the gradient based on its relative mean particle size and/or particle size distribution.

10. A method of making a ceramic blank suitable for use in dental reconstruction, the method comprising:
mixing a solution comprising a first population of ceramic particles having a first set of particle size properties, and a second population of ceramic particles having a second set of particle size properties, wherein at least one of the set of particle size properties is different between the first population and the second population;
pouring the mixed solution into a mold;
forming a particle gradient based on the first and second sets of particle size properties;
forming the ceramic blank by filtration.

11. The method of claim 10, wherein the first population of ceramic particles is provided as a first colloidal solution of the first population of ceramic particles, and the second population of ceramic particles is provided as a second colloidal solution of the second population of ceramic particles.

12. The method of claim 10, wherein the solution further comprises one or more additional populations of ceramic particles, each said population of ceramic particles having a set of particle size properties associated therewith, wherein each additional population of ceramic particles contributes to the gradient based on its set of particle size properties.

13. The method of claim 10, wherein each set of particle size properties is selected from average particle size, particle size distribution, number of particles, or a combination thereof.

14. The method of claim 10, wherein one or more other property is associated with each of said first and second population, wherein the one or more other property is independently selected from color, ability to absorb/adsorb color, aluminum oxide content, yttrium oxide content, strength, translucency, or combinations thereof.

15. The method of claim 10, wherein one or more other property is associated with each of said first and second population, wherein the one or more other property is yttrium oxide content.

16. The method of claim 10, wherein one or more other property is associated with each of said first and second population, wherein the one or more other property is independently selected from color, ability to absorb/adsorb color, aluminum oxide content, strength, translucency, or combinations thereof.

17. A ceramic blank suitable for use in dental reconstruction, the ceramic blank comprising:
a gradient of ceramic particles of at least two distinct ceramic particle populations, each having a different average particle size.
